(19) United States
(12) Patent Application Publication
(10) Pub. No.: US 2006/0252435 A1
(43) Pub. Date: Nov. 9, 2006

(54) Enabling application wakeup on a mobile device with a hybrid client

(75) Inventors: Irvin Henderson, Palo Alto, CA (US); Naveen D. Sanjeeva, Milpitas, CA (US); Thyagarajapuram S. Ramakrishnan, Saratoga, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/084,821

(22) Filed: Mar. 18, 2005

(51) Int. Cl. H04Q 7/20

(52) U.S. Cl. 455/466

(57) ABSTRACT

A system, apparatus, and method are directed to managing a message communications to a mobile device. The mobile device may include a first application that is unresponsive to a wakeup alert from a server. For example, the first application may be an instant messaging (IM) client that is developed as a mobile java application (MIDlet) that employs a MIDP1.0 specification, and the like. If the first application is determined to be unresponsive to a wakeup alert, the server may reformat a message to another message communication format, such as Short Messaging Service (SMS), for use by a second application that is responsive to the wakeup alert. The server may provide the reformatted message to the second application, which may be employed respond to the message. Alternatively, an end-user of the mobile device may wakeup the first application, for use in responding to the message.

### FIELD OF THE INVENTION

The invention relates generally to mobile communications, and more particularly but not exclusively to managing a message communications to a mobile device with a hybrid client environment.

### BACKGROUND OF THE INVENTION

The use of mobile technologies is steadily on the increase, for both business and personal uses. Mobile phones are a common site today and many people own personal information management (PIM) devices, palmtop computers, and so forth, to manage their schedules, contacts, and to stay connected with friends, family, and work. Employees on the move often appreciate the value of staying connected with their business through their mobile devices.

With such a variety of mobile devices, one can receive email messages, Instant Messaging (IM) messages, and Short Message Service (SMS) text messages, in addition to regular voice calls. With the growing proliferation of such mobile devices, it is becoming ever more important to ensure that employees, friends, and family are able to remain seamlessly connected to each other.

However, often an application residing on a mobile device may transition to a sleep or inactive state when it is not active. Such transitions are typically directed towards conserving resources of the mobile device. This transition may also occur when an end-user device takes steps to switch to another application on the mobile device. It may then become desirable to wakeup the inactive or sleeping application when a message is to be handled by that application. However, some applications, such as some employing Mobile Information Device Profile (MIDP) version 1.0 Application Programming Interface (API), and the like, may be unresponsive to a wakeup alert from a remote server device. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a mobile device that may be included in a system implementing the invention;

FIG. 3 shows one embodiment of a server device that may be included in a system implementing the invention;

FIG. 4 illustrates a logical flow diagram generally showing one embodiment of a process for managing a message communications for wakeup of a client on a mobile device over a network; and

FIG. 5 illustrates a logical flow diagram generally showing one embodiment of a client process for managing a receipt of a message communications on the mobile device, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards a system, apparatus, and method for managing a message communications to a mobile device over a network. The mobile device may include a first application that is unresponsive to a wakeup alert from a server. For example, the first application may be an instant messaging (IM) client that is developed as a mobile java application (MIDlet) employing the MIDP1.0 API, and the like. However, the invention is not limited to applications employing the MIDP1.0 API, and virtually any environment and/or application that is unresponsive to wakeup alerts from a remote computing device may be addressed by the present invention. In any event, if the first application is determined to be unresponsive to a wakeup alert from a remote computing device, the server is enabled to reformat a message to another message communication format, such as Short Messaging Service (SMS), and the like. The other communications format is selected for a second application on the mobile device that is configured to be responsive to the remote wakeup alert. In one embodiment, the server provides the wakeup alert to the mobile device to enable the first application to fetch the reformatted message. In another embodiment, the server provides the reformatted message and the wakeup alert to the mobile device for use by the second application. The second application may then be employed to respond to the message. Alternatively, an end-user of the mobile device may wakeup the first application for use in responding to the message.

Illustrative Operating Environment

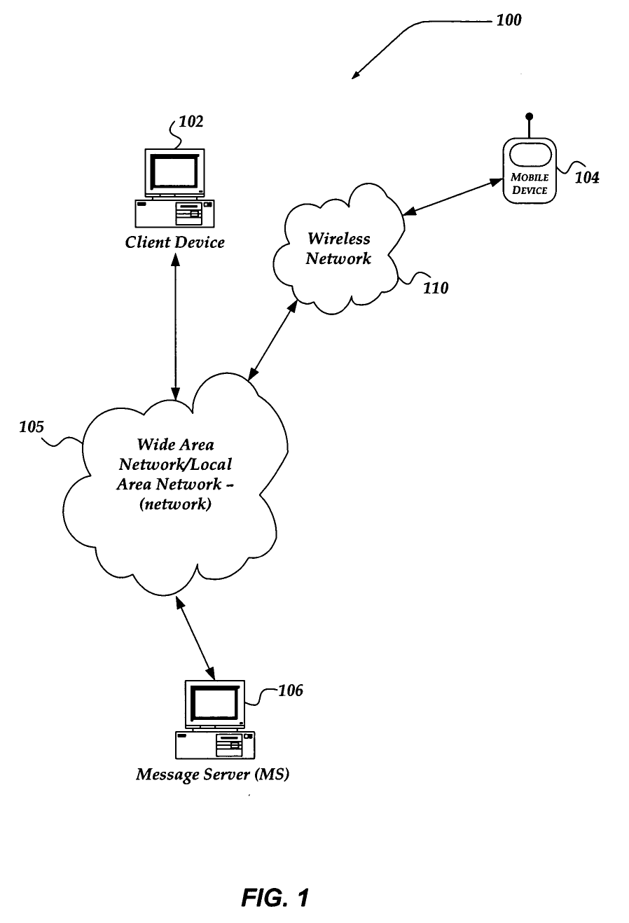

FIG. 1 shows components of an exemplary environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(collectively, “network 105”), wireless network 110, Message Server (MS) 106, client device 102, and mobile device 104. Client device 102 is in communication with mobile device 104 through MS 106, network 105, and wireless network 110.

Generally, client device 102 may include virtually any computing device capable of receiving and sending a message over a network, such as network 105, wireless network 110, and the like, to and from another computing device, such as MS 106, mobile device 104, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client device 102 also may be any computing device that is capable of connecting using a wired or wireless communication medium such as a PDA, POCKET PC, laptop computer, wearable computer, mobile phone and any other device that is equipped to communicate over a wired and/or wireless communication medium.

Client device 102 may include a browser application that is configured to receive and to send web pages, web-based messages, and the like. The browser application may be configured to receive and display graphics, text, multimedia, and the like, employing virtually any web based language, including Standard Generalized Markup Language (SMGL), HyperText Markup Language (HTML), eXtensible Markup Language (XML), and so forth.

Client device 102 may further include a client application that enables it to perform a variety of other actions, including, communicating a message, such as through a Short Message Service (SMS), Multimedia Message Service (MMS), instant messaging (IM), internet relay chat (IRC), Mardam-Bey's IRC (mIRC), Jabber, and the like, between itself and another computing device. The browser application, and/or another application, such as the client application, a plug-in application, and the like, may enable client device 102 to communicate content to another computing device, such as mobile device 104.

Mobile device 104 represents one embodiment of a client device that is configured to be portable. Thus, mobile device 104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile device 104 typically ranges widely in terms of capabilities and features. For example, a cell phone may have a numeric keypad and a few lines of monochrome LCD display on which only text may be displayed. In another example, a web-enabled remote device may have a touch sensitive screen, a stylus, and several lines of color LCD display in which both text and graphics may be displayed. Moreover, the web-enabled remote device may include a browser application enabled to receive and to send wireless application protocol messages (WAP), and the like. In one embodiment, the browser application is enabled to employ a Handheld Device Markup Language (HDML), Wireless Markup Language (WML), WMLScript, JavaScript, XML, and the like, to display and send a message.

Mobile device 104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile device 104 may uniquely identify itself through any of a variety of mechanisms, including a phone number, Mobile Identification Number (MIN), an electronic serial number (ESN), Mobile Subscriber Integrated Services Digital Network (MS-ISDN), or other mobile device identifier. The information may also indicate a configuration of an application residing on mobile device 104. For example, the information may indicate whether the application is responsive to wakeup alerts from another computing device, such as MS 106, and the like. In one embodiment, this information is provided during each communication. In another embodiment, at least some of the information may be provided during a predetermined event occurrence, such as upon a request for the information, during a login to a server, and the like.

Mobile device 104 may also be configured to communicate a message, such as through a SMS, MMS, IM, IRC, mIRC, Jabber, and the like, between another computing device, such as MS 106, client device 102, and the like. However, the present invention is not limited to these message protocols, and virtually any other message protocol may be employed.

Client device 102 and mobile device 104 may be further configured to enable a user to participate in a communications session, such as IM sessions, and the like, and to transfer an existing communications session, and the like, between devices. As such, client device 102 and mobile device 104 may include a client application that is configured to manage various actions on behalf of the client device. For example, the client application may enable a user to interact with the browser application, email application, IM applications, SMS application, and the like, to manage signing into a communications session, such as an IM session, between the devices.

In one embodiment, mobile device 104 may employ more than one client application, with each client application being configured to manage a different communications protocol. For example, mobile device 104 may include a client application that manages IM messages, and another client application that manages SMS messages. Moreover, the client applications may employ different underlying mechanisms. For example, the IM messaging client application may be implemented as a MIDlet within the Java 2 Platform, Micro Edition (J2ME), using the MIDP1.0 API. The SMS messaging client application, however, may be implemented as a UNIX application, a Windows Mobile™ application, a Symbian® application, and the like.

In addition, the client application on mobile device 104 may provide information to MS 106 indicating a configuration of its client applications, including whether a client application is responsive/non-responsive to a wakeup alert from MS 106, and the like. Moreover, mobile device 104's application may provide a periodic status message update to MS 106 indicating whether a client application is active, asleep, and the like.

Client device 102, and mobile device 104, may further be configured to include a client application that enables the end-user to log into an end-user account that may be managed, at least in part, by MS 106. Such end-user account, for example, may be configured to enable the end-user to receive emails, send/receive IM messages, SMS messages, access selected web pages, and the like. Moreover, the end-user account may be further configured to enable the end-user authorization to automatically start a communications session, such as an SMS session, and the like, on mobile device 104.

Wireless network 110 is configured to couple mobile device 104 and its components with network 105. Wireless network 110 may include any of a variety of wireless sub-networks that may further overlay stand-alone ad-hoc networks, and the like, to provide an infrastructure-oriented connection for mobile device 104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile device 104 and another computing device, network, and the like.

Network 105 is configured to couple MS 106 and its components with other computing devices, including, client device 102, MS 106, and through wireless network 110 to mobile device 104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between MS 106 and another computing device.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

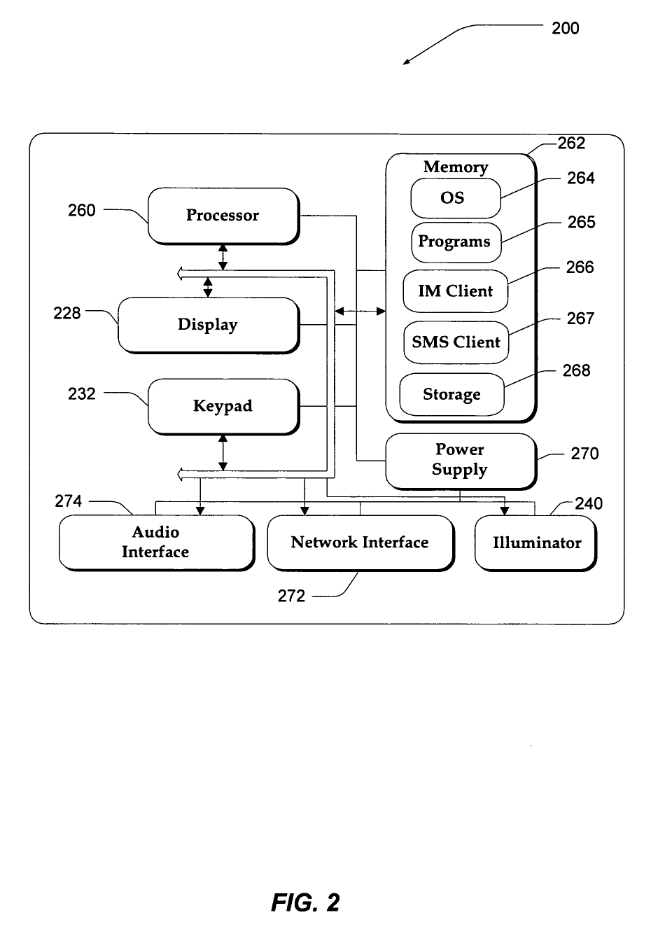

One embodiment of MS 106 is described in more detail below in conjunction with FIG. 2. Briefly, however, MS 106 may include any computing device capable of connecting to network 105 to manage message communications between one or more computing devices, such as between client device 102 and mobile device 104. MS 106 may receive information from the other computing devices that indicate whether the computing devices are configured with a client application that is responsive/non-responsive to a wakeup alert from MS 106. If a client application is determined to be non-responsive to a wakeup alert message from MS 106, MS 106 may reformat a received message into another communications format, for another client application that is responsive to a wakeup alert. MS 106 may then provide a wakeup alert to mobile device 104 to enable the responsive client application to obtain the reformatted message.

MS 106 may be further configured to provide and manage end-user accounts that are configured to provide such services to the end-user as, for example, email, access to games, selected web pages, chat sessions, IM sessions, SMS sessions, social networks, and the like. However, the present invention is not constrained by such examples, and more or less services may be provided, without departing from the scope or spirit of the invention.

Devices that may operate as MS 106 include personal computers desktop computers, multiprocessor systems, microprocessor-based or programmable consumer electronics, network PCs, servers, and the like.

Although FIG. 1 illustrates MS 106 as a single computing device, the invention is not so limited. For example, one or more functions of MS 106 may be distributed across one or more distinct computing devices. For example, IM sessions may be managed by a different computing device than are web services. Similarly, SMS sessions, session transfers, authentication, and the like, may reside on different computing devices, without departing from the scope or spirit of the present invention.

Illustrative Mobile Client Environment

FIG. 2 is a functional block diagram illustrating an embodiment of one embodiment of communications device 200 for practicing the present invention. In one embodiment of the present invention communications device 200 is implemented as a mobile communications device, such as a PDA, smart phone, and the like that is arranged to send and receive voice communications, and other messages, such as IM messages, SMS messages, and the like via one or more wireless communication interfaces. Communications device 200 may also include handheld computers, tablet computers, personal computers, multiprocessor systems, microprocessor-based or programmable consumer electronics, network PCs, wearable computers, and the like. Communications device 200 may be represent, for example, mobile device 104 of FIG. 1.

Communications device 200 may include many more components than those shown in FIG. 2. The components shown, however, are sufficient to disclose an illustrative embodiment for practicing the invention.

As shown in the figure, communications device 200 includes processor 260, memory 262, display 228, and keypad 232. Memory 262 generally includes both volatile memory (e.g., RAM) and non-volatile memory (e.g., ROM, Flash Memory, or the like). Communications device 200 includes operating system 264, which may be resident in memory 262 and configured to execute on processor 260 for use in controlling operations of communications device 200. It will be appreciated that this component may include a general purpose operating system such as a version of UNIX, LINUX™, and the like, or a specialized mobile communication operating system such as Windows Mobile™, Symbian®, or the like. The operating system may further include, or interface with a Java Virtual Machine module that enables control of various hardware components and/or operating system operations via Java application programs, and the like. Moreover, memory 262 may include components such as MIDP1.0 APIs, J2ME components, and the like.

Keypad 232 may be a push button numeric dialing pad (such as on a typical telephone), a multi-key keyboard (such as a conventional keyboard), and the like. Display 228 may be a liquid crystal display (LCD), gas plasma, light emitting diode (LED), or any other type of display useable in a mobile communications device. For example, display 228 may be touch-sensitive, and may then also act as an input device enabling entry of stencil input, touch display, and so forth.

One or more programs 266 may be loaded into memory 262 and run on the operating system 264. Programs 266 may include computer executable instructions which, when executed by mobile communications device 200, also transmit, receive, and/or otherwise process web pages, audio, videos, graphics, and enable telecommunication with another computing device. Other examples of programs 266 include calendars, contact managers, task managers, transcoders, email programs, scheduling programs, browsers, word processing programs, spreadsheet programs, games, and the like. In addition, memory 262 may include IM client 266 and SMS client 267.

IM client 266 is intended to represent a client application that may be non-responsive to a wakeup alert from another computing device, such as a remote server. For example, IM client 266 may represent one embodiment of a client application that is configured as a MIDlet employing the MIDP1.0 APIs. SMS client 267 is provided to represent one embodiment of another client application configured to be responsive to a wakeup alert from another computing device, such as a remote server. For example, SMS client 267 may employ another programming language and associated set of APIs. However, the invention is not limited to these examples, and others may be employed.

Communications device 200 also includes non-volatile storage 268 within memory 262. Non-volatile storage 268 may be used to store persistent information which is intended not to be lost if the communications device 200 is powered down. Programs 266 may use and store information in storage 268, such as e-mail or other messages used by an e-mail application, databases, documents used by a word processing application, and the like. A synchronization application may also reside on communications device 200 and be programmed to interact with a corresponding synchronization application resident on another computer to keep the information stored in storage 268 synchronized with corresponding information stored at the other computer.

Communications device 200 also may include power supply 270, which may be implemented as one or more batteries, solar devices, and the like. Power supply 270 might further include an external power source, such as an AC adapter or a powered docking cradle that supplements or recharges the batteries.

Communications device 200 is also shown with two types of external notification mechanisms: illuminator 240 and audio interface 274. These devices may be directly coupled to power supply 270 so that when activated, they remain on for a duration dictated by the notification mechanism even though processor 260 and other components might shut down to conserve battery power. Illuminator 240 may be programmed to remain on indefinitely until the user takes action to indicate the powered-on status of the device. Audio interface 274 may be used to provide audible signals to and receive audible signals from the user. For example, audio interface 274 may be coupled to a speaker for providing audible output and to a microphone for receiving audible input, such as to facilitate a telephone conversation.

Communications device 200 also includes network interface 272 that performs the function of transmitting and receiving external communications. Network interface 272 facilitates, for example, wireless connectivity between communications device 200, and the outside world, via a communications carrier or service provider. Transmissions to and from network interface 272 may be conducted under control of operating system 264. In other words, communications received by network interface 272 may be disseminated to programs 266 via operating system 264, and vice versa. Network interface 272 also allows communications device 200 to communicate with other computing devices, such as over a network, using a variety of wired communications mechanisms and technologies, including global system for mobile communications (GSM), code division multiple access (CDMA), time division multiple access (TDMA), user datagram protocol (UDP), transmission control protocol/Internet protocol (TCP/IP), SMS, general packet radio service (GPRS), Wireless Application Protocol (WAP), ultra wide band (UWB), IEEE 802.16 Worldwide Interoperability for Microwave Access (WiMax), and the like. Network interface 272 is sometimes known as a transceiver or transceiving device, and is one example of a communication media.

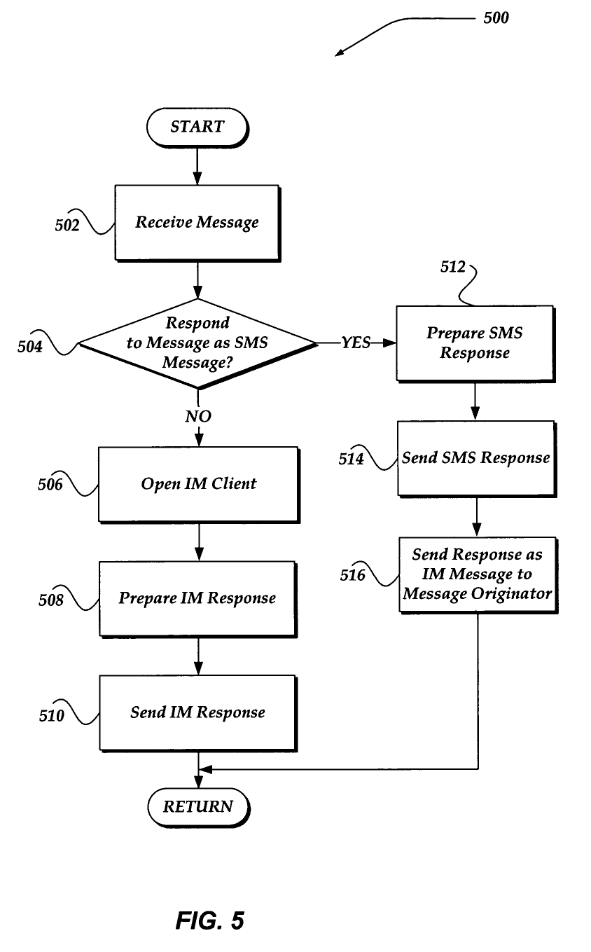

Communications device 200 may employ one or more components to provide information to identify itself during an external communications with another device. Communications device 200 may uniquely identify itself through any of a variety of mechanisms, including a phone number, Mobile Identification Number (MIN), an electronic serial number (ESN), Mobile Subscriber Integrated Services Digital Network (MS-ISDN), or other mobile device identifier. The information may also indicate a content format that mobile device 104 is enabled to employ, a device type, capability, and the like. The information may further indicate whether one or more client applications on communications device 200 are non-responsive/responsive to a remote wakeup alert. In addition, information may be provided indicating a status of such client applications, including whether the client application is active, such as by sending a ping message; asleep; and the like. The information may be provided as part of another message, and/or as a separate message to the other device. Moreover, communications device 200 may employ a process, such as process 500 of FIG. 5, to perform at least some of its actions.

Illustrative Server Environment

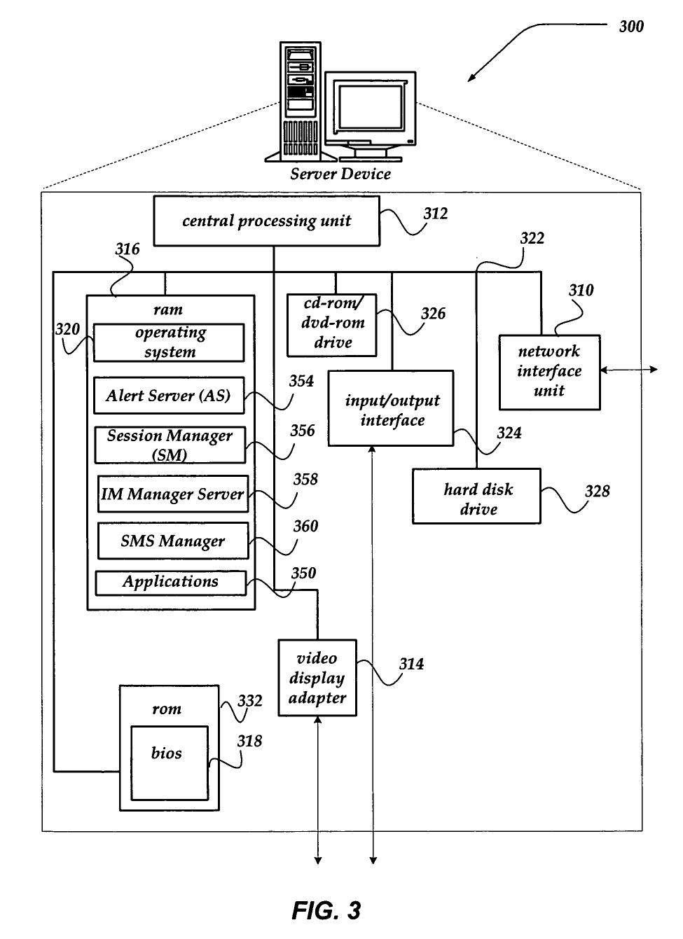

FIG. 3 shows one embodiment of a server device, according to one embodiment of the invention. Server device 300 may include many more components than those shown. The components shown, however, are sufficient to disclose an illustrative embodiment for practicing the invention. Server device 300 may, for example, represent MS 106 of FIG. 1.

Server device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of server device 300. Any general-purpose operating system may be employed. Basic input/output system (“BIOS”) 218 is also provided for controlling the low-level operation of server device 300. As illustrated in FIG. 3, server device 300 also can communicate with the Internet, or some other communications network, such as network 105 in FIG. 1, via network interface unit 310, which is constructed for use with various communication protocols including the TCP/IP protocol. Network interface unit 310 is sometimes known as a transceiver, transceiving device, network interface card (NIC), and the like.

Server device 300 may also include an SMTP handler application for transmitting and receiving email. Server device 300 may also include an HTTP handler application for receiving and handing HTTP requests, and an HTTPS handler application for handling secure connections. The HTTPS handler application may initiate communication with an external application in a secure fashion.

Server device 300 also includes input/output interface 324 for communicating with external devices, such as a mouse, keyboard, scanner, or other input devices not shown in FIG. 3. Likewise, server device 300 may further include additional mass storage facilities such as CD-ROM/DVD-ROM drive 326 and hard disk drive 328. Hard disk drive 328 is utilized by server device 300 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs include email programs, schedulers, calendars, transcoders, database programs, word processing programs, spreadsheet programs, and so forth. Mass storage may further include applications such as Alert Server (AS) 354, Session manager 356, IM manager server 358, and SMS manager 360.

IM manager server 358 includes virtually any server application configured to manage an IM session with another computing device. Similarly, SMS manager 360 includes virtually any server application configured to manage an SMS message session with another computing device. Although only these two communications managers are illustrated, it is clear that the invention is not so limited and virtually any message communications manager may be employed.

AS 354 is configured to manage client wakeups and, as appropriate, the reformatting of a message destined for a computing device. AS 354 may receive information from a computing device that includes a device identifier, such as a mobile device identifier, and the like. AS 354 may further receive information about a client application residing on the computing device, including information indicating whether the client application may be awaken using a remote wakeup alert, a status of the client application, and the like. AS 354 may provide the received information to Session manager 356, where Session manager 356 includes virtually any component configured to store and manage such information, including a spreadsheet, a database, a file, an application, and the like.

AS 354 may receive a message from a computing device that is destined for another computing device. AS 354 may employ the information stored in Session manager 356 to determine whether the destination computing device includes a client application that is responsive to receipt of the message, a wakeup alert, and the like. For example, AS 354 may determine that the received message is an IM message and that an IM client application on the destination device is non-responsive to a wakeup alert from server device 300. If AS 354 determines that the IM client application is unresponsive, but another client application is responsive, such as an SMS client application, AS 354 may reformat the message for the other client application. Thus, in this example, AS 354 may reformat the received IM message as an SMS message.

In one embodiment, AS 354 may forward the reformatted SMS message to the destination computing device employing a common short code (CSC), sometimes known as simply a short code. Briefly, short codes are typically short strings of numbers to which a text message may be addressed and includes a common addressing scheme for participating wireless networks. Short codes are designed to provide a way to deploy interactive mobile data applications, including voting, polling, “text and win” contests, surveys, focus groups, direct marketing, live chats, games, and the like. Short codes typically are assigned to a designation, an origin, and the like. For example, in one embodiment, AS 354 may have assigned to it, the short code of “92466.” However, it is clear that AS 354 may employ virtually any message origin identifier. For example, AS 354 may employ an Internet Protocol (IP) address, and the like. Thus, while short codes are described, the invention is not so limited.

AS 354 may be further configured to enable a use of short code extensions, or simply “extensions,” to indicate, at least in part, an end-user of the original message. Briefly, such “extensions” may include virtually any alpha character, a numeric character, symbol, and/or any combination of alpha, numeric, and/or symbols. For example, AS 354 may employ a numeric range of numbers, such as from ‘101’ to ‘400,’ to indicate a source of the original message. In one embodiment, AS 354 may further employ information within a contact list, and the like, to determine an extension. For example, AS 354 may determine if the end-user sending the message is within a contact list associated with the destination end-user. Extension may also be employed to identify a sender that may not be in a contact list of the destination end-user. AS 354 may assign an extension based on the sending end-user's information within the contact list. Thus, in one embodiment, AS 354 may send the reformatted message to the destination computing device, as an SMS message indicating that the message is from “92466” with extension that indicates that the sender is identifiable within the destination end-user's contact list. However, the invention may employ any of a variety of mechanisms to identify the sender of the message, and is not constrained to this example. Furthermore, AS 354 may, in one embodiment, employ a wakeup alert, to wakeup the SMS client application on the destination computing device. In this manner, the present invention may provide timely messages between computing devices.

In addition, server device 300 may be configured to manage end-user accounts that are configured to provide such services to an end-user as, for example, email, access to games, selected web pages, chat sessions, IM sessions, SMS sessions, social networks, and the like. However, the present invention is not constrained by such examples, and more or less services may be provided, without departing from the scope or spirit of the invention. In one embodiment, an account identifier and password is employable to enable an end-user to access such services, including an ability to register a mobile device. In one embodiment, the end-user accounts reside within server device 300. In another embodiment, the end-user accounts, and/or management thereof, are distributed across one or more computing devices.

Generalized Operation

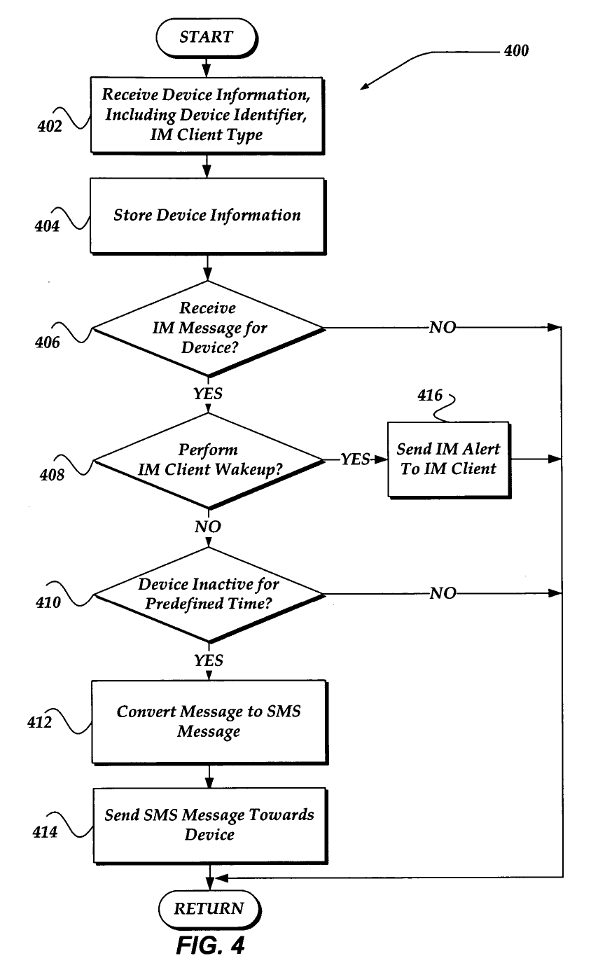

The operation of certain aspects of the invention will now be described with respect to FIG. 4. FIG. 4 illustrates a logical flow diagram generally showing one embodiment of a process for managing a message communications for waking up a client application on a mobile device, over a network. Process 400 of FIG. 4 may, for example, be implemented within MS 106 of FIG. 1.

For the purpose of illustration, process 400 assumes that the client application that is non-responsive to a wakeup alert from a remote computing device is an IM client application, and that the client application that is responsive to the wakeup alert is an SMS client application. However, clearly, the invention is not so constrained, and other message communications protocols may be applicable.

Process 400 begins, after a start block, at block 402, where device information is received, such as from a mobile device. The information may, for example, be initially received, when an end-user of the mobile device seeks to log into an account. However, the invention is not limited to this, and the information may be received from the mobile device during other conditions, events, and the like. For example, in one embodiment, device information may be provided when the mobile device seeks to obtain a message. In any event, the information may include a mobile device identifier, a type, a capacity, and the like. The information may also include information about a client application residing on the mobile device, including a type of client, a capability of the client, a status of the client application, and the like. For example, in one embodiment, the client application information may indicate whether the client application is responsive/non-responsive to a wakeup alert from another computing device. In one embodiment, a status of a client application may be determined when a ping message is received from the client application, and the like to determine if the client is active or not. Processing next proceeds to block 404, where the received information is stored. In one embodiment, the information is stored using a mechanism that enables access based on a client application, a device identifier, and the like.

Process 400 continues to decision block 406, where a determination is made whether an IM message is received. As stated above, the IM message is employed here as one example of a possible message type for a non-responsive message client application. In any event, if it is determined, that an IM message is not received, processing returns to a calling process to perform other actions, such as providing a wakeup alert to the mobile device to enable the mobile device to access the received message.

If, at decision block 406, an IM message is received, processing proceeds to decision block 408, where a determination is made whether to provide an IM Client application wakeup alert. An IM client application wakeup alert may be provided if the IM client application is configured to be responsive to such an alert. Moreover, the wakeup alert may be provided if the IM client application is not active. Such determination may be made based, for example, on the device and client application information obtained at block 402 and stored at block 404. If it is determined that the IM client application is non-responsive to a remote wakeup alert (an alert from a remote device, such as MS 106 of FIG. 1), then processing branches to decision block 410; otherwise, processing branches to block 416. At block 416, a wakeup alert, such as an IM alert is sent to the IM Client application to wake it up. In one embodiment, the IM Client application may then access the received message. In another embodiment, the IM alert may also include the actual text of the message. There upon, processing returns to a calling process to perform other actions.

At decision block 410, a determination is made whether the mobile device has been inactive for a predefined period of time. Determination of inactivity may be made, for example, based on activity recorded on a server, and the like. In any event, if the mobile device has been active, then no alert might be sent out, as it may be assumed that the mobile device will poll for messages. However, if it is determined that the mobile device has been inactive for a predefined period of time, processing continued to block 412, where, the received message is reformatted to another message format, to be received by another client application on the mobile device that is responsive to a remote wakeup alert. In this example, the message is reformatted as an SMS message.

Processing continues to block 414, where the reformatted message is provided towards to mobile device. In one embodiment, the SMS message is sent to the mobile device employing a short code and extension, where the extension indicates an origin of the original message. In one embodiment, the SMS message operates as a wakeup alert to the responsive client application. Upon completion of block 414, processing returns to the calling process to perform other actions.

FIG. 5 illustrates a logical flow diagram generally showing one embodiment of a client process for managing a receipt of a message communications on the mobile device, in accordance with the present invention. Process 500 of FIG. 5 may, for example, be implemented in mobile device 104 of FIG. 1.

Process 500 begins, after a start block, at block 502, where a message is received. As described above for FIG. 4, it is assumed for illustrative purposes, that the non-responsive client application (to a wakeup alert from a remote device) is an IM client application, and the responsive client application is an SMS client application, however, the invention is not so limited and other client applications may be applicable. Thus, in this example, the received message is an SMS message. The SMS client application may be awakened to receive the end-user the message. In one embodiment, the SMS message includes information indicating the server providing the message and the message origin. For example, such information may be provided employing a short code for the server identifier, and an extension indicating the message origin. In one embodiment, the text of the message itself may indicate the identity of the actual sender as well.

Processing continues at decision block 504, where a determination is made whether to respond to the received SMS message employing the SMS client application. If it is determined that a response is to be provided using the SMS client application, processing flows to block 512, where the SMS client application is employed to prepare a response. Processing then flows to block 514, where the prepared response is sent using the SMS client application. Process 500 flows next to block 516, where in one embodiment of the invention, the response is sent to the originator of the message as an IM message. Processing then returns to a calling process to perform other actions.

Alternatively, if, at decision block 504, it is determined that a response is not to be provided by the SMS client application, processing flows to block 506, where another client application is opened. In this example process flow, the other client application is an IM client application. Processing continues next to block 508, where a response to the received SMS message is prepared employing the IM client application. Processing flows next to block 510, where the prepared IM response is sent using the IM client application. Upon completion of block 510, processing returns to the calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of managing a message communications over a network, comprising:
receiving information associated with a mobile device, wherein the information comprises information about a first client application on the mobile device, and information about a second client application on the mobile device;
receiving a message destined for the mobile device and formatted for the first client application;
if the first client application is non-responsive to a wakeup alert from another computing device, and the second client application is responsive to a wakeup alert from the other computing device, reformatting the message for the second client application; and
providing a wakeup alert to the mobile device indicating that the reformatted message is available for the second client application.

2. The method of claim 1, wherein the first client application is an IM client.

3. The method of claim 1, wherein the first client application is configured to employ an Mobile Information Device Profile (MIDP) version 1.0 Application Programming Interface (API).

4. The method of claim 1, wherein the second client application is a Short Message Service (SMS) client application.

5. The method of claim 1, wherein reformatting the message further comprises transforming the message into an SMS message.

6. The method of claim 1, further comprising:
receiving the reformatted message by the second client application; and
employing the first client application to provide a response message.

7. The method of claim 1, wherein reformatting the message further comprises employing at least one of a short code and an extension.

8. The method of claim 1, wherein receiving information associated with the mobile device further comprises:
receiving information indicating that the first client application is non-responsive to a wakeup alert from another computing device and that the second client application is responsive to a wakeup alert from the other computing device.

9. A server device for use in managing a message communications with a mobile device, comprising:
a transceiver for receiving and sending information between the mobile device;
a processor in communication with the transceiver; and
a memory in communication with the processor and for use in storing data and machine instructions that cause the processor to perform a plurality of operations, including:
receiving information associated with the mobile device, indicating information about a first client application on the mobile device, and information about a second client application on the mobile device;
receiving a message destined for the mobile device and formatted for the first client application;
if the first client application is non-responsive to a wakeup alert from another computing device, and the second client application is responsive to the wakeup alert, reformatting the message for the second client application; and
providing a wakeup alert to the mobile device indicating that the reformatted message is available for the second client application.

10. The server device of claim 9, wherein the first client application is an Instant Messaging (IM) client.

11. The server device of claim 9, wherein the first client application is configured to employ an Mobile Information Device Profile (MIDP) version 1.0 Application Programming Interface (API).

12. The server device of claim 9, wherein the mobile device is further configured to perform actions, including:
receiving the reformatted message by the second client application; and
employing the first client application to provide a response message.

13. The server device of claim 9, the second client application is configured to provide a ping message to the server device.

14. A mobile device for use in managing a message communications over a network, comprising:
(a) a display;
(b) a transceiver for receiving and sending information between another computing device;
(c) a first messaging client in communication with the transceiver and is configured to perform a plurality of actions, including:
providing information about the first client application to another computing device; and
(d) a second messaging client in communication with the transceiver and is configured to perform a plurality of actions, including:
providing information about the second client application to another computing device; and
if the first client application is non-responsive to a wakeup alert from another computing device, and the second client application is responsive to the wakeup alert, receiving a wakeup alert from the other computing device indicating that a message is available to the second client application, wherein the message is reformatted from a format for use by the first client application to another format for use by the second client application.

15. The mobile device of claim 14, wherein the first client application is an IM client and the second client application is a Short Message Service (SMS) client application.

16. The mobile device of claim 14, wherein the first client application is configured to employ an Mobile Information Device Profile (MIDP) version 1.0 Application Programming Interface (API).

17. The mobile device of claim 14, wherein the message is reformatted from a format for use by the first client application to another format further comprises converting the message from an Instant Messaging (IM) message to a Short Message Service (SMS) message.

18. The mobile device of claim 14, wherein the message is reformatted from a format for use by the first client application to another format further comprises employing at least one of a short code and an extension.

19. A modulated data signal for managing a message communications, the modulated data signal comprising instructions that enable a computing device to perform the actions of:
sending to a server device, from a mobile device, information associated with the mobile device, including information about a first client application on the mobile device, and information about a second client application on the mobile device;
receiving, at the server device, a message destined for the mobile device and formatted for the first client application;
if the first client application is non-responsive to a wakeup alert from server device, and the second client application is responsive to the wakeup alert, enabling a reformatting of the message for use by the second client application; and
sending, from the server device, a wakeup alert to the mobile device indicating that the reformatted message is available for the second client application.

20. The modulated data signal of claim 19, wherein the first client application is configured to employ an Mobile Information Device Profile (MIDP) version 1.0 Application Programming Interface (API).

21. The modulated data signal of claim 19, wherein the first client application is an IM client and the second client application is a Short Message Service (SMS) client application.

22. An apparatus for use in managing a registration of a mobile device over a wireless network, comprising:
a transceiver configured to receive and to send a message over the wireless network; and
a processor, coupled to the transceiver, that is arranged to perform actions, including:
a means for receiving information associated with a mobile device, including information about a first client application on the mobile device, and information about a second client application on the mobile device;
a means for receiving a message destined for the mobile device and formatted for the first client application;
a means for determining if the first client application is non-responsive to a wakeup alert from another computing device, and the second client application is responsive to the wakeup alert, and if so determined, a means for reformatting the message for use by the second client application; and
a means for providing the reformatted message to the second client application.
